(19) United States
(12) Patent Application Publication
(10) Pub. No.: US 2007/0217090 A1
(43) Pub. Date: Sep. 20, 2007

(54) PLASMA DISCHARGED STATIC ELIMINATOR

(76) Inventor: Makoto TAKAYANAGI, Shizuoka (JP)

Correspondence Address: Leighton K. Chong;Patent Attorney, 133 Kaai Street, Honolulu, HI, 96821, US

(21) Appl. No.: 11/680,263

(22) Filed: Feb. 28, 2007

(30) Foreign Application Priority Data
Mar. 2, 2006 (JP) 2006-055714

(51) Int. Cl. H02H 3/00

(52) U.S. Cl. 361/1

(57) ABSTRACT

There is provided a plasma discharged static eliminator comprises a power supply, electrodes and a plasma discharging electrode portion comprised of a dielectric covering the electrodes. The plasma generated by a dielectric-barrier discharge in which the dielectric functions as a barrier is used as a charged molecules source or an electrons source.

### TECHNICAL FIELD

This invention generally relates to a plasma discharged static eliminator, and more particularly, to a plasma discharged static eliminator using dielectric barrier discharge.

### BACKGROUND OF THE INVENTION

Conventionally corona discharge, glow discharge, ultraviolet light, X-ray, and radioactive ray have been used as an ion generating source for use in a static eliminator.

With the corona discharge or the glow discharge, molecules or particles are generated from electrodes, which results in deterioration of cleanliness in clean environment. In addition, the electrodes are depleted, which leads to a short life of static eliminator.

Furthermore, nitrogen oxide or Nox is generated due to the reaction of nitrogen and dioxide in the air, and then the crystals of ammonium nitrate are generated due to the reaction of the generated nitrogen oxide and moisture content, that is, water in the air. When the crystals of ammonium nitrate are scattered around, the environment is contaminated. Furthermore, since high voltage electrodes for use in the corona discharge are exposed there is a risk that persons would get electric shock.

Meanwhile, although no above-mentioned contamination is generated when the X-ray or the radioactive ray is utilized, human bodies would be exposed to the X-ray or the radioactive ray.

Therefore, it is an object of the present invention to provide a plasma discharged static eliminator which overcomes the above-mentioned problems.

### SUMMARY OF INVENTION

To accomplish the object, there is provided a plasma discharged static eliminator which comprises a power supply, electrodes and a plasma discharging electrode portion comprised of a dielectric covering said electrodes, in which plasma generated by a dielectric-barrier discharge in which said dielectric functions as a barrier is used as charged molecules source or electrons source.

Other objects, features, and advantages of the present invention will be explained in the following detailed description of the invention having reference to the appended drawings:

### BRIEF DESCRIPTION OF DRAWINGS

FIG. 1 shows a first embodiment of static eliminator according to the present invention,

FIG. 2 shows a second embodiment of static eliminator according to the present invention for explanation of a mechanism for statically eliminating the object to be discharged,

FIG. 3 shows a plasma discharging electrode portion of a third embodiment according to the present invention,

FIG. 4 shows a plasma discharging electrode portion of a fourth embodiment according to the present invention,

FIG. 5 shows a plasma discharging electrode portion of a 5th embodiment according to the present invention,

FIG. 6 shows a plasma discharging electrode portion of a 6th embodiment according to the present invention, and

FIG. 7 shows a plasma discharging electrode portion of a 7th embodiment according to the present invention in which various electrodes are disposed.

### DETAILED DESCRIPTION OF THE INVENTION

### First embodiment

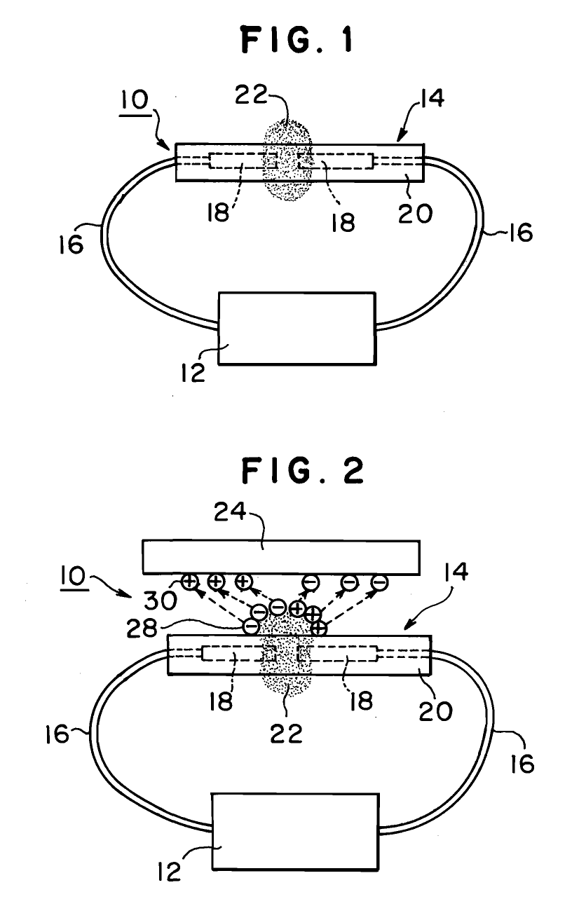

FIG. 1 shows a first embodiment of static eliminator according to the present invention. In FIG. 1 a plasma discharged static eliminator 10, hereinafter referred to as a static eliminator, comprises a power supply 12, a plasma discharging electrode portion 14 for generating plasma discharge, and a conductor 16 for connecting the power supply 12 and the plasma discharging electrode portion 14 to supply power from the power supply 12 to the plasma discharging electrode portion 14.

The plasma discharging electrode portion 14 includes a pair of opposite electrodes 18 that are opposed to each other in position and have electrically opposite polarities, and a dielectric 20 covering the opposite electrodes 18. The conductor 16 connects the opposite electrodes 18 and the power supply 12. The plasma 22 is generated around the circumference of the portion of the dielectric 20 between or near the leading ends of the opposite electrodes 18.

It is preferred that the power supply for plasma discharge has a more than 1K voltage in more than 1 KHz A.C. Also, it is preferred that the dielectric constant of the dielectric 20 is bigger since the power supply is made to be more compact. For this reason, in general it is preferred that the dielectric constant is more than 10 F/m. Since the dielectric with dielectric constant of 140 F/m has been put into practical use, it is preferred that such a dielectric is used.

### Second embodiment

FIG. 2 shows a second embodiment of static eliminator according to the present invention for explanation of a mechanism for statically eliminating the object to be discharged. In FIG. 2, plasma 22 comprises ions, that is, charged molecules 28 of plus polarity and of minus polarity or electrons 28, and is neutral as a whole. When a charged body 24 comes close to the plasma, the plus charged static 30 attracts minus charged molecules or electrons in the plasma and then the electrical charge disappears. On the contrary, the minus charged static 30 attracts plus charged molecules in the plasma and then electrical charge disappears. In this way, the charges of opposite polarities combine each other and the static elimination is made by the plasma 22.

### Third embodiment

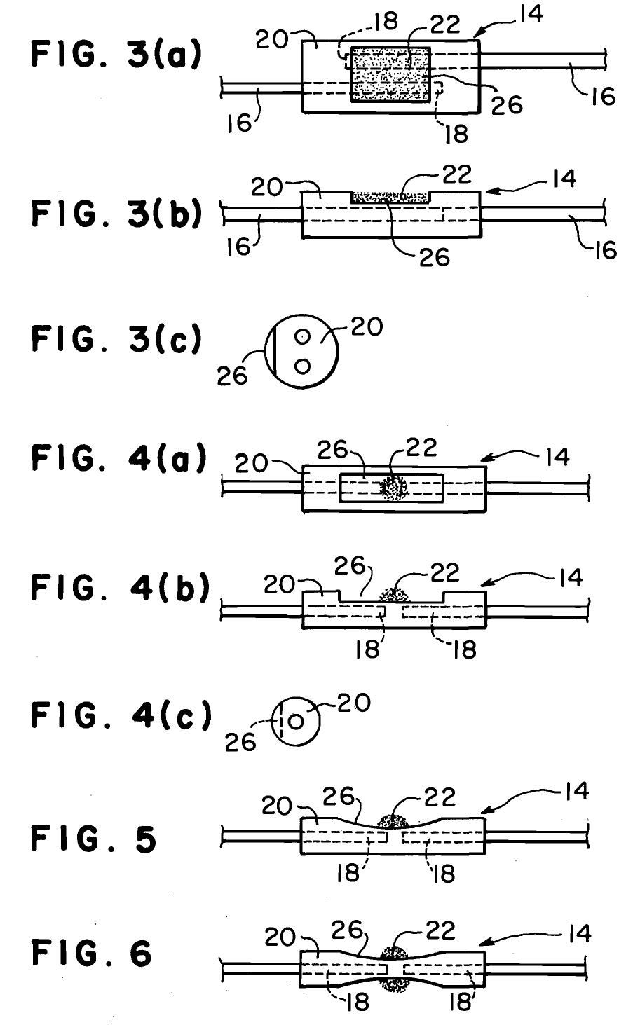

FIG. 3 shows a plasma discharging electrode portion of a third embodiment according to the present invention. In FIG. 3, although in the first embodiment a pair of opposite electrodes 18 is constructed so that the leading ends of the opposite electrodes are opposed to each other, in this third embodiment the opposite electrodes 18 are disposed to be parallel. The plasma is generated at the most thin portion of the dielectric 20 between the parallel electrodes 18. More specifically, the dielectric 20 is formed with a recess or a notch 26 at or near the superimposed portion of the parallel opposite electrodes 18. In other words, the dielectric 20 is provided with weaker portion of insulation performance. An elongated line of plasma generating source is formed within the notch 26.

### 4th Embodiment

FIG. 4 shows a plasma discharging electrode portion of a fourth embodiment according to the present invention. In FIG. 4, the opposite electrodes 18 are opposed to each other at the leading ends thereof. The dielectric 20 is formed with a recess or a notch 26 at or near the leading ends of opposite electrodes. The plasma 22 is generated at the leading ends of the electrodes, that is, the most thin portion of the dielectric, in other words, within the notch.

### 5th Embodiment

FIG. 5 shows a plasma discharging electrode portion of a 5th embodiment according to the present invention. Although in the 4th embodiment the notch is of a cuboid, in the 5th embodiment the notch 26 is of a circular arc in section.

### 6th Embodiment

FIG. 6 shows a plasma discharging electrode portion of a 6th embodiment according to the present invention. In the 6th embodiment the opposite electrodes are opposed to each other at the leading ends thereof in a similar way to that of the 5th embodiment. The dielectric is formed with a recess or a notch 26 around the circumference of the dielectric at or near the leading ends of opposite electrodes 18 and thus the plasma is generated around the circumference of the most thin portion of dielectric at the leading ends of the electrodes.

### 7th Embodiment

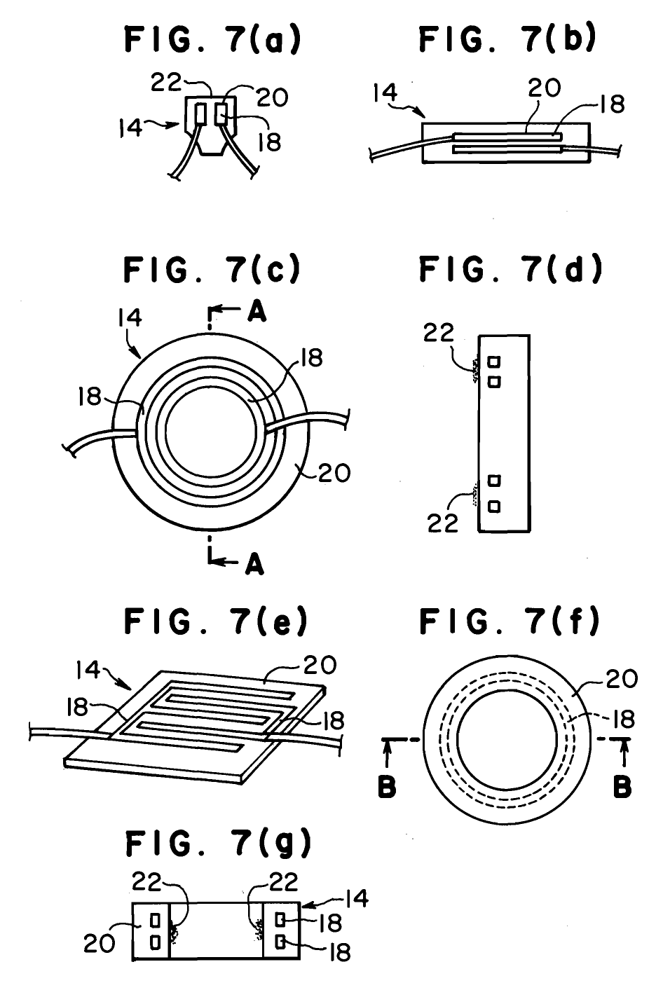

FIG. 7 shows a plasma discharging electrode portion of a 7th embodiment according to the present invention in which various electrodes are disposed. FIG. 7a shows a plasma source with point-like electrodes. Since the portion of dielectric at the leading ends of opposite electrode is formed to be the most thin, insulation performance at that portion is low and thus the plasma is generated at that portion. The spot static elimination can be carried out by this point-like plasma.

FIG. 7b shows a line-like plasma source. Since the opposite electrodes are disposed to be parallel, line-like plasma is generated.

FIG. 7c, and FIG. 7d taken along lines A-A of the FIG. 7c show a circular plasma. A circular plasma is generated.

FIG. 7e shows a planar plasma Since plurality of parallel electrodes are disposed in a planar alignment, planar plasma is generated.

FIG. 7f and FIG. 7g taken along lines B-B of the FIG. 7d show a cylindrical plasma. Cylindrical plasma is generated inside or outside. In the case that cylindrical plasma is generated inside, a material body such as fine molecules which pass though a pipe can be statically eliminated.

### Other Embodiments

The charged molecules or electrons generated by plasma discharge may be made to fly away by a compressed air or a blower. Generation of ozone may be kept down using inert gas.

It is understood that many modifications and variations may be devised given the above description of the principles of the invention. It is intended that all such modifications and variations be considered as within the spirit and scope of this invention, as it is defined in the following claims.

1. A plasma discharged static eliminator which comprises a power supply, electrodes and a plasma discharging electrode portion comprised of a dielectric covering said electrodes, in which plasma generated by an dielectric-barrier discharge in which said dielectric functions as a barrier is used as charged molecules source or electrons source.

2. A plasma discharged static eliminator according to claim 1 which supplies the charged molecules or electrons generated from said plasma to a charged body to neutralize electric charge thereof.

3. A plasma discharged static eliminator according to claim 1 in which said electrodes in the dielectric are a pair of opposite electrodes and a.c. voltage of more than 1 KV in more than 1KHz is applied between the opposite electrodes.

4. A plasma discharged static eliminator according to claim 1 in which the dielectric is provided adjacent to the pair of opposite electrodes with a weaker portion of insulation performance.

5. A plasma discharged static eliminator according to claim 1 in which the dielectric is provided adjacent to the pair of opposite electrodes with a weaker portion of insulation performance in a point-like configuration, a line-like configuration or in a planar configuration.

6. A plasma discharged static eliminator according to claim 1 in which the dielectric is provided adjacent to the pair of opposite electrodes with a thinner portion than other portion to increase the density of electric flux lines outside the dielectric.

7. A plasma discharged static eliminator according to claim 1 in which the charged molecules or electrons generated by plasma discharge are made to fly away by a compressed air or a blower.

8. A plasma discharged static eliminator according to claim 1 in which generation of ozone is kept down using inert gas.

9. A plasma discharged static eliminator according to claim 1 in which the dielectric constant of said dielectric is more than 10 F/m.

10. A plasma discharged static eliminator according to claim 1 in which said opposite electrodes are of a point-like configuration, a line-like configuration, a circular configuration, or a cylindrical configuration.

11. A plasma discharged static eliminator according to claim 1 in which said opposite electrodes are disposed in a planar alignment.
